(19) United States
(12) Patent Application Publication
(10) Pub. No.: US 2025/0174950 A1
(43) Pub. Date: May 29, 2025

(54) CRIMPING TOOL FOR NETWORK JACK

(71) Applicant: Ningbo Dan-chiff Network Technologies Co. Ltd., Ningbo City (CN)

(72) Inventor: John PENG, New Taipei (TW)

(21) Appl. No.: 18/626,662

(22) Filed: Apr. 4, 2024

(30) Foreign Application Priority Data
Nov. 27, 2023 (TW) 112145908

(51) Int. Cl. H01R 43/042

(52) U.S. Cl. CPC H01R 43/0421

(57) ABSTRACT

The present invention involves a crimping tool, which comprises a tool body; a blade holder configured on the tool body; a support base configured on the tool body and having a jack-urging portion and a first receiving region to accommodate a 180° jack therein; and a switching block having a second receiving region, movably connected with the support base and cooperating with the support base to accommodate a 90° jack in the first receiving region and the second receiving region, wherein when the blade holder is used to crimp wires into the 180° jack, the jack-urging portion bears a force exerted by the blade holder.

### CROSS-REFERENCE TO RELATED APPLICATIONS

This application claims the priority of Taiwan Application application No. 112145908, filed on Nov. 27, 2023.

### FIELD OF THE INVENTION

The present invention relates to a crimping tool for a network jack, and in particular, to one that can be used for either a 90° jack or a 180° jack by switching a switching block cooperating with a support base.

### BACKGROUND OF THE INVENTION

For a network connector (also called a network jack, a network module, etc.), the two main designs for jacks are 90-degree) (90° and 180-degree) (180°. The “degree” referred to here is the angle at which a network cable is punched down into a jack. A 90° punch-down means the network cable connects down into the top of the jack, forming a 90-degree angle. A 180° punch-down means the cable connects straight into the back of the jack. Both angles work well in a variety of installations. If the installation is in a server room, with multiple jacks in a blank patch panel, 180° jacks are preferred because installing them is quicker and more convenient. If a jack is connected to an external outlet box, it is usually more convenient to use a 90° jack. Therefore, 90° jacks are more suitable for use in buildings, and 180° jacks can be used in both server rooms and buildings. For fast crimping tools applied to connectors, the current crimping tools can electrically connect a connector to wires at a very fast speed and can also remove the excess core wires (i.e., conducting wires, 8 and 4 core wires for network cables and voice cables, respectively), and there is no need to change the specifications of the existing connectors and wires. However, the 90° and 180° network jacks are of different types, which are suitable for different cutting blade processes and different sizes and shapes of wire bonding bases (i.e., the IDC holders/piercing type terminal holders), so that a blade holder of a crimping tool cannot be shared for the two jack types. Therefore, before leaving a factory, it is necessary to decide which corresponding cutter head should be installed on the crimping tool according to the jack types. Currently, there is a two-in-one crimping device for communication connectors, which is a crimping device that can perform crimping and cutting operations on two different types of communication connectors by two different cutter heads, but it is very inconvenient to replace cutter heads at an operation place.

There is also another crimping hand tool, in which different crimping heads (which also refers to a crimping and cutting piece, a blade holder, a cutter head, etc.) can be interchanged and a receiving holder for a jack with two different receiving areas can be rotated to switch between operations of 90° and 180° jacks. The main advantage of this tool is that it uses a single receiving holder with multiple receiving areas to accommodate 90° and 180° jacks. However, when switching for different jacks, the blade holder needs to be replaced accordingly, which is inconvenient. In addition, in order to switch for 90° and 180° jacks, the receiving holder is pivoted along a lower rotatable shaft perpendicular to the horizontal body of the tool. When crimping, the blade holder will exert a horizontal crimping thrust on the jack, but because only the rotatable shaft below the direction of the force is served as the jack-urging object, and the rotatable shaft and the blade holder are not located on the same horizontal plane, the thrust force may cause a risk of tipping over easily.

At present, there is no commercial crimping tool that allow 90° and 180° jacks to share the same blade holder. This is because if the outline dimensions of wire bonding bases of jacks are slightly different, the cutter heads must be re-customized. That is, one jack only fits one cutter head.

Therefore, in view of the defects of the conventional crimping tools, such as the inconvenience caused by the need for replacing cutter heads and easy tipping caused by rotation for switching the operated jack, etc., the applicants of the present application developed the present invention to overcome the disadvantages of conventional technologies. The descriptions of the present invention are as follows:

### SUMMARY OF EXEMPLARY EMBODIMENTS

One object of the present invention is to provide a crimping tool. The crimping tool comprises a tool body; a blade holder configured on the tool body; a support base configured on the tool body and having a jack-urging portion and a first receiving region to accommodate a 180° jack therein; and a switching block having a second receiving region, movably connected with the support base and cooperating with the support base to accommodate a 90° jack in the first receiving region and the second receiving region, wherein when the blade holder is used to crimp wires into the 180° jack, the jack-urging portion bears a force exerted by the blade holder.

Another object of the present invention is to provide a crimping tool. The crimping tool comprises a tool body; a workpiece configured on the tool body to perform a wire crimping and cutting operation on either a 90° jack or a 180° jack; a first working region provided on the tool body to accommodate a 180° jack within the first working region; and a workpiece retainer forming a second working region with the tool body to accommodate the 90° jack within the second working region, wherein when the workpiece works on the 90° jack, the workpiece retainer is located within the tool body.

Another object of the present invention is to provide a crimping tool. The crimping tool comprises a tool body; a workpiece configured on the tool body to perform a wire crimping and cutting operation on either a 90° jack or a 180° jack, wherein when the workpiece performs the wire crimping and cutting operation, the workpiece moves in a first direction; a first working region provided on the tool body to accommodate the 180° jack within the first working region; and a workpiece retainer having a rotatable shaft connecting the workpiece retainer with the tool body, wherein the workpiece retainer together with the tool body form a second working region to accommodate the 90° jack within the second working region, wherein the rotatable shaft has an axial direction, and the axial direction and the first direction both extend in a horizontal direction.

### BRIEF DESCRIPTION OF THE DRAWINGS

The embodiments and advantages of the present invention will become more readily apparent to those ordinarily skilled in the art after reviewing the following detailed descriptions and accompanying drawings.

FIG. 1 is a three-dimensional exploded view schematic diagram of a preferred embodiment of a crimping tool for a network jack of the present invention.

FIG. 2 is a three-dimensional schematic diagram showing the blade holder, the support base and the switching block in FIG. 1.

FIG. 3 is a three-dimensional schematic diagram showing a 90° jack placed in the crimping tool of the present invention.

FIG. 4 is a three-dimensional schematic diagram showing a 180° jack placed in the crimping tool of the present invention.

FIG. 5 is a three-dimensional cross-sectional schematic diagram showing the switching block arranged on the support base in FIG. 1.

FIG. 6 is a cross-sectional schematic diagram showing the switching block fixed on the support base in FIG. 1.

FIG. 7 is a three-dimensional schematic diagram showing the crimping tool in FIG. 1 after assembly.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

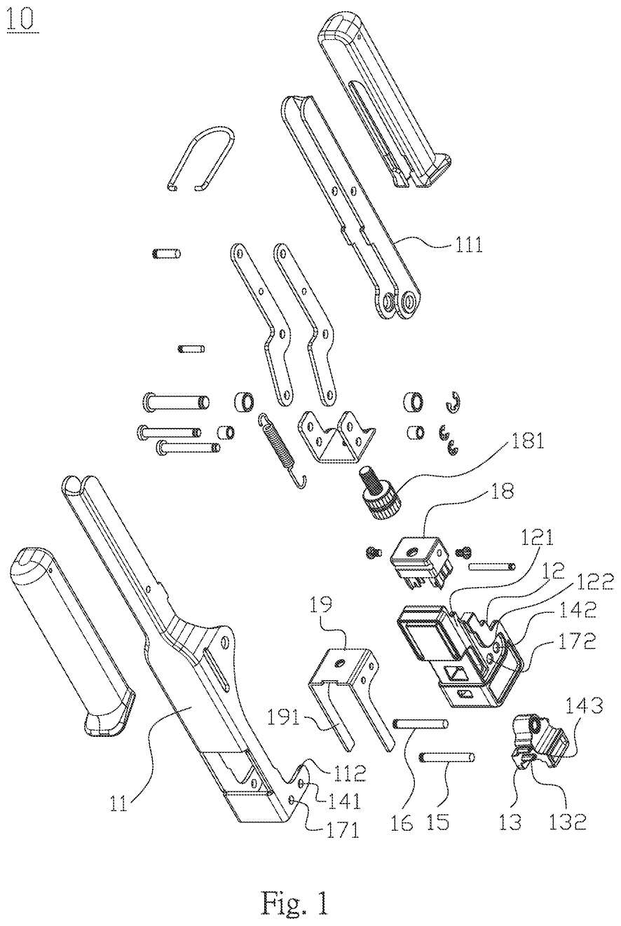

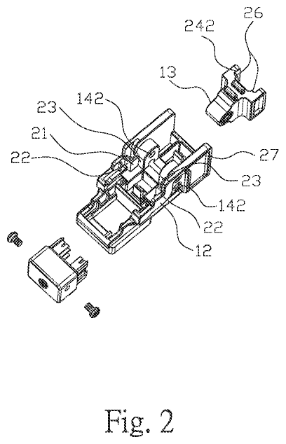

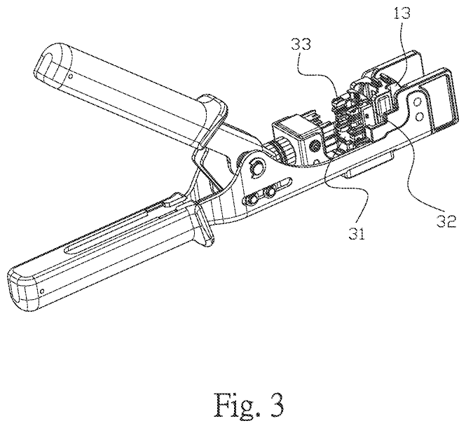

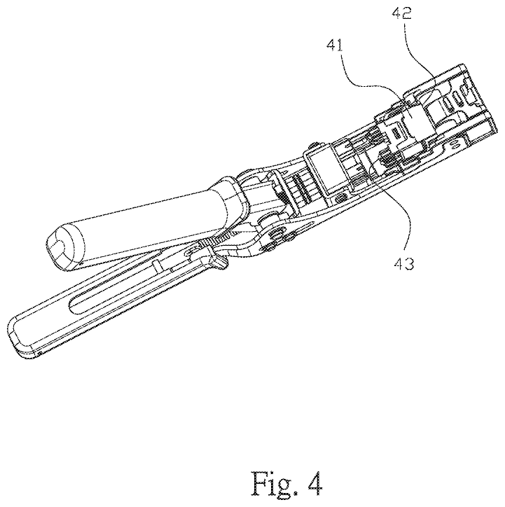

In order to make it possible to perform crimping and cutting operations on two types of jacks with only one cutter head, the dimensions of the wire bonding bases, especially where the wires are cut and crimped, of the 90° and 180° jacks must be designed to be consistent. The crimping tool for the network jacks proposed by the present invention can complete the cutting and crimping of two types of jacks, 90° and 180° jacks, by using only one cutter head without the need to replace cutter heads. Please refer to FIGS. 1 to 6 together, which show a crimping tool 10 for a network jack. The crimping tool 10 comprises a tool body 11 (which is usually made of iron), a support base 12 and a switching block 13, etc. The tool body 11 has a first shaft hole 141. The support base 12 is configured on the tool body 11 and comprises a first receiving region 21, a second shaft hole 142, a block-urging portion 22 and a 180° jack-urging portion 23 as shown in FIG. 2. The switching block 13 comprises a second receiving region 242, a third shaft hole 143 and a rotatable shaft 15, wherein the switching block 13 is rotatably connected to the support base 12 and the tool body 11 by the rotatable shaft 15 passing through the first shaft hole 141, the second shaft hole 142 and the third shaft hole 143. The rotatable shaft 15 causes the switching block 13 to change between a first position shown in FIG. 3 and a second position shown in FIG. 4. The switching block 13 can pivots 90° or 180° on the support base 12 by the rotatable shaft 15. When the switching block 13 is in the first position, the switching block 13 is located within a part of the first receiving region 21, and the block-urging portion 22 abuts the switching block 13, so that a remaining part of the first receiving region 21 and the second receiving region 242 of the switching block 13 form a 90° jack receiving space 32 for accommodating the 90° jack 31 as shown in FIG. 3. The second receiving region 242 of the switching block 13 includes a 90° jack-urging portion 26 to retain the 90° jack. When the switching block 13 is in the first position, the first receiving region 21 and the second receiving region 242 overlap and are configured together to receive the 90° jack for a crimping and cutting operation. When the switching block 13 is located in the second position, the switching block 13 is located partially or completely outside the first receiving region 21, the first receiving region 21 of the support base 12 and the 180° jack-urging portion 23 are respectively configured to receive and retain a 180° jack 41 and together form a 180° jack receiving space 42 for accommodating the 180° jack 41 as shown in FIG. 4. Since the first position is within the first receiving region 21 of the support base 12, when the switching block 13 moves to the second position, the switching block 13 is not within the first receiving region 21 of the support base 12. The dimension of the parts where the wires are cut and crimped in the wire bonding base 33 of the 90° jack 31 and in the wire bonding base 43 of the 180° jack 41 are designed to be consistent.

In the embodiment above, the crimping tool 10 further comprises a horizontal rod 16, the tool body 11 has a first rod hole 171, and the support base 12 has a second rod hole 172. The support base 12 is fixed to the tool body 11 by the horizontal rod 16 passing through the first rod hole 171 and the second rod hole 172. The crimping tool 10 further comprises a blade holder 18 configured on the tool body 11 for cutting and pressing core wires in the 90° jack 31 and the 180° jack 41. When the blade holder 18 cuts and presses core wires in the 90° jack 31, the 90° jack-urging portion 26 bears the force exerted by the blade holder 18. When the blade holder 18 cuts and presses core wires in the 180° jack 41, the 180° jack-urging portion 23 bears the force exerted by the blade holder 18.

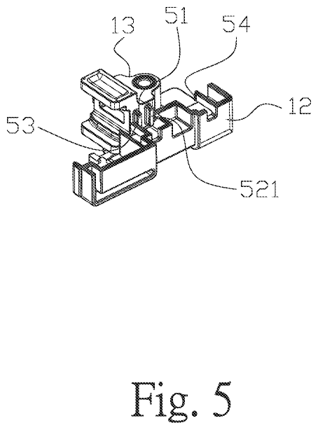

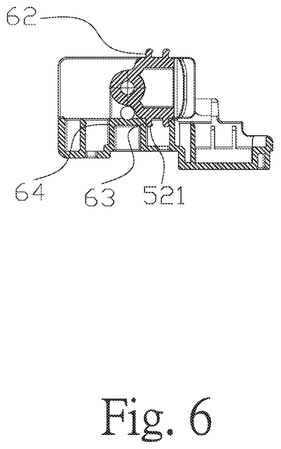

Please refer to FIG. 5. The switching block 13 has a first fastener 51 and a second fastener 132 for fastening the switching block 13. The support base 12 has a third fastener 53 and a fourth fastener 54. When the 90° jack is to be crimped, the third fastener 53 is used to connect (e.g., lock or engage) to the first fastener 51, and when the 180° jack is to be crimped, the fourth fastener 54 is used to connect (e.g., lock or engage) to the second fastener 132. The switching block 13 has a first positioning urging portion 521 and a second positioning urging portion 62 as shown in FIG. 6. The support base 12 has a third positioning urging portion 63 and a fourth positioning urging portion 64. When the 90° jack is to be crimped, the third positioning urging portion 63 is used to abut against the first positioning urging portion 521. When the 188° jack is to be crimped, the fourth positioning urging portion 64 is used to abut against the second positioning urging portion 62.

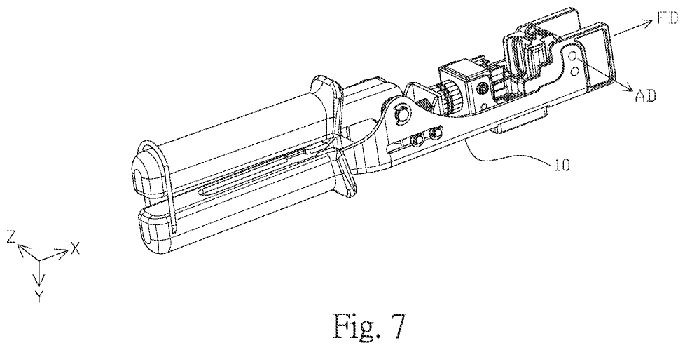

The support base 12 has one or more protective members 27 (e.g., protective covers) extending from the support base 12. When the switching block 13 is in the second position, the protective members 27 are configured outside the switching block 13 to protect the switching block 13. The crimping tool 10 includes a slider 19 that is slidably mounted on the tool body 11 to configure the blade holder 18 thereon. The slider 19 has extension arms 191, and the support base 12 has guide grooves 121 to guide the movement of the extension arms 191. The blade holder 18 is equipped with an adjustment screw 181 to adjust the crimping process of the blade holder 18. The crimping tool 10 includes a force member 111 configured on the tool body 11 and used to push the blade holder 18. The assembled crimping tool 10 is as shown in FIG. 7, and the horizontal plane in FIG. 7 refers to the plane formed by the X axis and the Z axis.

The present invention further provides a crimping tool 10, which comprises a tool body 11, a blade holder 18, a support base 12 and a switching block 13. The blade holder 18 is configured on the tool body 11. The support base 12 is configured on the tool body 11 and has a jack-urging portion (such as a 180° jack-urging portion 23) and a first receiving region 21 to accommodate a 180° jack therein. The switching block 13 having a second receiving region 242 is movably connected with the support base 12 and cooperates with the support base 12 to accommodate a 90° jack in the first receiving region 21 and the second receiving region 242. When the blade holder 18 is used to crimp wires into the 180° jack 41, the jack-urging portion bears a force exerted by the blade holder 18.

Compared with the embodiments above, the crimping tool 10 can be designed such that the support base 12 does not include a block-urging portion 22 (not shown in the figures). In this case, the tool body 10 has a first shaft hole 141, the support base 12 has a second shaft hole 142, the switching block 13 has a rotatable shaft 15 and a second receiving region 242. The switching block 13 is rotatably connected to the support base 12 and the tool body 11 by the rotatable shaft 15 passing through the first shaft hole 141 and the second shaft hole 142, wherein the rotatable shaft 15 bears the force exerted by the blade holder 18. When the switching block 13 is located in a part of the first receiving region, the 90° jack 31 can be accommodated within a space formed by a remaining part of the first receiving region 21 and the second receiving region 242 of the switching block 13, so that the blade holder 18 can crimp wires into the 90° jack 31. During the crimping process, only the rotatable shaft 15 but not together with the block-urging portion 22 bears the force exerted by the blade holder 18. This embodiment is also feasible.

Compared with the embodiments above, the crimping tool 10 can also be designed without the rotating shaft 15 (not shown in the figures). In this case, the switching block 13 can be directly taken out from the support base 12. The switching block 13 has a second receiving region 242, the support base 12 has second shaft holes 142 on both sides, and the crimping tool 10 further includes a first screw and a second screw opposite to the first screw (not shown in the figures), which pass through the second shaft holes 142 on both sides for fixing the support base 12 to the tool body 11. When the switching block 13 is in the first position, the first receiving region 21 and the second receiving region 242 are configured to receive a 90° jack for a crimping and cutting operation by the blade holder 18. When the switching block 13 moves to the second position, the first receiving region 21 and the jack-urging portion are respectively configured to receive and retain a 180° jack for the crimping and cutting operation by the blade holder 18. In this embodiment, the first position is in the first receiving region 21 of the support base 12, and the second position is not in the first receiving region 21 of the support base 12. In an embodiment, the crimping tool 10 comprises a block-urging portion 22 integrally formed with the support base 12. In an embodiment, the switching block 13, the jack-urging portion, the block-urging portion 22 and the blade holder 18 are on the same horizontal plane, and when the blade holder 18 is used to crimp wires into the 90° jack 31, the switching block 13 and the block-urging portion 22 bear the force exerted by the blade holder 18.

In one embodiment, the crimping tool has a tool body integrally formed with a support base (not shown in the figures). In this case, without the rotating shaft and without using the first and second screws to fix the support base to the tool body, the tool body and the support base may integrally be made of plastic to bear the force exerted by the blade holder. In another embodiment, the tool body 11 and the support base 12 are not integrally formed. Instead, the support base 12 has coupling portions 122 on both sides to respectively couple to the base urging portions 112 on both sides of the tool body 11, which can also bear the force exerted by the blade holder 18 without the need for using the rotating shaft 15. In an embodiment, the switching block 13 pivoting about the horizontal axis in the figures is changed from the original horizontal position to a vertical lifting/lowering structure of the switching block in the support base. In an embodiment, the switching block 13 is replaced in such a manner that the switching block is divided into left and right blocks, and the left and right blocks can be separate or close relative to each other in the horizontal direction (which is perpendicular to the direction in which the blade holder is pressed forward). In actual applications, the switching block 13 may be embodied by the structures described above, but is not limited thereto.

The present invention also provides a crimping tool 10, which comprises a tool body 11, a workpiece (e.g., the blade holder 18), a first working region (e.g., the first receiving region 21) and a workpiece retainer (e.g., the switching block 13). The workpiece is configured on the tool body 11 to perform a wire crimping and cutting operation on either a 90° jack or a 180° jack. The first working region is provided on the tool body 11 to accommodate the 180° jack 41 within the first working region. The workpiece retainer has a rotatable shaft 15 connecting the workpiece retainer with the tool body 11, wherein the workpiece retainer together with the tool body 11 form a second working region (e.g., the second receiving region 242) to accommodate the 90° jack within the second working region. When the workpiece works on the 90° jack, the workpiece retainer is located within the tool body. When the workpiece works on the 180° jack, at least a portion of the workpiece retainer is located outside the tool body.

The present invention also provides a crimping tool 10, which comprises a tool body 11, a workpiece (e.g., the blade holder 18), a first working region (e.g., the first receiving region 21) and a workpiece retainer (e.g., the switching block 13). The workpiece is configured on the tool body 11 to perform a wire crimping and cutting operation on either a 90° jack or a 180° jack. When the workpiece performs the wire crimping and cutting operation, the workpiece moves in a first direction FD (as shown in FIG. 7). The first working region is provided on the tool body 11 to accommodate the 180° jack 41 within the first working region. The workpiece retainer has a rotatable shaft 15 connecting the workpiece retainer with the tool body and is configured on the tool body 11. The workpiece retainer together with the tool body 11 form a second working region (e.g., the second receiving region 242) to accommodate the 90° jack 31 within the second working region. The rotatable shaft 15 has an axial direction AD (as shown in FIG. 7), and the axial direction AD and the first direction FD both extend in a horizontal direction. The axial direction AD is orthogonal to the first direction FD.

The present invention further provides a crimping tool 10, which comprises a tool body 11, a workpiece (e.g., the blade holder 18), a first working region (e.g., the first receiving region 21) and a workpiece retainer (e.g., the switching block 13). The workpiece is configured on the tool body 11 to perform a wire crimping and cutting operation on either a 90° jack or a 180° jack. The first working region is provided on the tool body 11 to accommodate the 180° jack 41 within the first working region. The workpiece retainer together with the tool body 11 form a second working region (e.g., the second receiving region 242) to accommodate the 90° jack 31 within the second working region. The first working region is formed independently of the workpiece retainer.

The present invention further provides a crimping tool 10, which comprises a tool body 11, a workpiece (e.g., the blade holder 18), a first working region (e.g., the first receiving region 21) and a workpiece retainer (e.g., the switching block 13). The workpiece is configured on the tool body 11 to perform a wire crimping and cutting operation on either a 90° jack or a 180° jack. The workpiece is configured on the tool body 11 to perform a wire crimping and cutting operation on either a 90° jack or a 180° jack. The first working region is provided on the tool body 11 to accommodate the 180° jack 41 within the first working region. The workpiece retainer together with the tool body 11 form a second working region (e.g., the second receiving region 242) to accommodate the 90° jack 31 within the second working region. The first working region is formed independently of the workpiece retainer. When the workpiece performs a wire crimping and cutting operation on the 180° jack 41, the workpiece retainer is located outside the tool body 11, and the 180° jack within the first working region is not in contact with the workpiece retainer.

In an embodiment, the first working region and the second working region are formed within the tool body. In an embodiment, the axial direction is orthogonal to the first direction. In an embodiment, the 90° jack within the second working region is secured by the workpiece retainer, and the 180° jack within the first working region is not in contact with the workpiece retainer. In an embodiment, the workpiece retainer changes between a first position within the tool body and a second position outside the first working region by the rotatable shaft, wherein when the workpiece retainer is in the first position, the second working region is formed, and when the workpiece retainer is in the second position, the first working region is formed.

In view of the above, the present invention provides a new structure of a crimping tool, on which a 90° jack receiving space and a 180° jack receiving space can be easily switched by a switching block movably connected with a support base and cooperating with the support base, and a horizontal rotatable shaft in the crimping tool enables the support base to fully withstand the lateral thrust force of a blade holder. In summary, the implementations of this disclosure can be modified in many ways by those skilled in the art, which are all included within and belong to the defined scope of the appended claims that the Applicant desires to protect.

What is claimed is:

1. A crimping tool, comprising:
a tool body;
a blade holder configured on the tool body;
a support base configured on the tool body and having a jack-urging portion and a first receiving region to accommodate a 180° jack therein; and
a switching block having a second receiving region, movably connected with the support base and cooperating with the support base to accommodate a 90° jack in the first receiving region and the second receiving region,
wherein when the blade holder is used to crimp wires into the 180° jack, the jack-urging portion bears a force exerted by the blade holder.

2. The crimping tool as claimed in claim 1, wherein when the switching block is located in a part of the first receiving region, the 90° jack is accommodated within a space formed by a remaining part of the first receiving region and the second receiving region of the switching block, so that the blade holder can crimp wires into the 90° jack.

3. The crimping tool as claimed in claim 1, wherein the tool body has a first shaft hole, the support base has a second shaft hole, the switching block has a rotatable shaft passing through the first shaft hole and the second shaft hole and bearing the force exerted by the blade holder, and the switching block is rotatably connected to the support base and the tool body through the rotatable shaft.

4. The crimping tool as claimed in claim 2, wherein the support base has two second shaft holes, and the crimping tool further comprises a first screw and a second screw opposite to the first screw, which pass through the two second shaft holes respectively to fix the support base on the tool body.

5. The crimping tool as claimed in claim 2, wherein the switching block changes between a first position and a second position by the rotatable shaft, and when the switching block is in the first position, the first receiving region and the second receiving region are configured to receive a 90° jack for a crimping and cutting operation by the blade holder.

6. The crimping tool as claimed in claim 5, wherein the first position is within the first receiving region of the support base.

7. The crimping tool as claimed in claim 5, wherein when the switching block moves to the second position, the first receiving region and the jack-urging portion are respectively configured to receive and retain a 180° jack for the crimping and cutting operation by the blade holder.

8. The crimping tool as claimed in claim 5, wherein when the switching block is in the second position, the switching block is not within the first receiving region of the support base.

9. The crimping tool as claimed in claim 1, further comprising:
a block-urging portion integrally formed with the support base, wherein the switching block, the jack-urging portion, the block-urging portion and the blade holder are on a same horizontal plane, and when the blade holder is used to crimp wires into the 90° jack, the switching block and the block-urging portion bear a force exerted by the blade holder.

10. The crimping tool as claimed in claim 1, wherein the tool body is integrally formed with the support base.

11. A crimping tool, comprising:
a tool body;
a workpiece configured on the tool body to perform a wire crimping and cutting operation on either a 90° jack or a 180° jack;
a first working region provided on the tool body to accommodate a 180° jack within the first working region; and
a workpiece retainer forming a second working region with the tool body to accommodate the 90° jack within the second working region,
wherein when the workpiece works on the 90° jack, the workpiece retainer is located within the tool body.

12. The crimping tool as claimed in claim 11, wherein the first working region is formed independently of the workpiece retainer.

13. The crimping tool as claimed in claim 11, wherein when the workpiece works on the 180° jack, at least a portion of the workpiece retainer is located outside the tool body.

14. A crimping tool, comprising:
a tool body;
a workpiece configured on the tool body to perform a wire crimping and cutting operation on either a 90° jack or a 180° jack, wherein when the workpiece performs the wire crimping and cutting operation, the workpiece moves in a first direction;
a first working region provided on the tool body to accommodate the 180° jack within the first working region; and
a workpiece retainer having a rotatable shaft connecting the workpiece retainer with the tool body, wherein the workpiece retainer together with the tool body form a second working region to accommodate the 90° jack within the second working region,
wherein the rotatable shaft has an axial direction, and the axial direction and the first direction both extend in a horizontal direction.

15. The crimping tool as claimed in claim 14, wherein the first working region and the second working region are formed within the tool body.

16. The crimping tool as claimed in claim 14, the axial direction is orthogonal to the first direction.

17. The crimping tool as claimed in claim 14, wherein the 90° jack within the second working region is secured by the workpiece retainer, and the 180° jack within the first working region is not in contact with the workpiece retainer.

18. The crimping tool as claimed in claim 14, wherein the workpiece retainer changes between a first position and a second position by the rotatable shaft.

19. The crimping tool as claimed in claim 18, wherein when the workpiece retainer is in the first position, the second working region is formed, and when the workpiece retainer is in the second position, the first working region is formed.

20. The crimping tool as claimed in claim 18, wherein the first position is within the tool body and the second position is outside the first working region.
